(19) United States
(12) Patent Application Publication
(10) Pub. No.: US 2025/0092982 A1
(43) Pub. Date: Mar. 20, 2025

(54) Kink Resistant Hose Assembly

(71) Applicant: Jiawei Guo, Qingdao (CN)

(72) Inventor: Jiawei Guo, Qingdao (CN)

(21) Appl. No.: 18/469,497

(22) Filed: Sep. 18, 2023

(51) Int. Cl. F16L 57/06

(52) U.S. Cl. CPC F16L 57/06; F16L 33/30; F16L 33/2071; F16L 33/2078

(57) ABSTRACT

Disclosed is a hose assembly integrating a male coupling, a fixedly attached bearing, and a hand grip system. Some embodiments further comprise a hose tube. In such embodiments, the hose tube has both proximal and distal ends, with the male coupling attached to the proximal end. The bearing system connects an inner race to the male coupling and an outer race, which rotates around the inner race. This bearing links to a hand grip, facilitating ease of manipulation and preventing kinks. Some embodiments utilize UV-resistant materials and integrate water filters, ensuring clean water flow. An expandable hose design, anti-leak features, and optional integrated hose reel are also described. The fixed connection between the male coupling and the hose tube promoted durability.

### TECHNICAL FIELD

The present invention relates to hose assemblies, and more specifically to a hose assembly with an integrated hand grip, male coupling, and bearing system that facilitates easy handling, connection, and functionality of hoses.

### BACKGROUND OF THE INVENTION AND PRIOR ART

Traditional water hoses, ubiquitous in gardens and outdoor spaces worldwide, have long been a mainstay for irrigation and cleaning purposes. Made from flexible tubing, these hoses are designed to transport water from a source to a desired location, often over significant distances. However, one of the most persistent and frustrating issues associated with traditional hoses is their propensity to kink. A kink occurs when a portion of the hose gets twisted or bent to such an extent that it obstructs the flow of water. Not only does this impede the hose's primary function, but repeated kinking can also weaken the hose's structural integrity, leading to leaks and reduced lifespan. The flexibility that makes hoses useful is the very quality that also makes them vulnerable to kinks, especially when they are improperly stored or carelessly dragged around obstacles in the garden.

Some hose assemblies aim to address these kinking issues by incorporating a rotatably coupled handle. Yet, in many of these designs, an external male coupling rotates alongside the handle, without a seamless integration with the hose's tubing or its internal male coupling. This disjointed design compromises the external coupling's durability and heightens the likelihood of the internal coupling developing leaks over prolonged use. Additionally, such assemblies tend to necessitate proprietary hose attachments tailored to the unique size of the external coupling. This limitation restricts users from employing generic, often more affordable, hose attachments, nudging them towards pricier proprietary alternatives.

Furthermore, prior art embodiments often feature handles that are permanently affixed to the couplings and/or hose, limiting the user's ability to interchange them with other handles better suited for specific gardening scenarios.

Thus there exists a demand in the industry for a robust, kink-resistant hose assembly that seamlessly integrates with generic components.

### BRIEF SUMMARY OF THE INVENTION

The invention comprises a unique hose assembly that incorporates a male coupling, bearing, and hand grip system. The hose tube has a proximal and distal end with the male coupling affixed to the proximal end. A bearing system, including an inner race attached to the male coupling and an outer race that is rotatably coupled to the inner race, is provided. A hand grip is fixedly attached at its proximal end to the outer race of the bearing and extends at its distal end away from the bearing, thus enabling a user to easily manipulate the hose during use while preventing kinking and the obstruction of water flow.

In some embodiments, the design of the hand grip includes ergonomic features which enhance user comfort during operation. Additionally, the hose tube may have an expandable design that facilitates easy storage and increased length when necessary.

Further embodiments provide that the hand grip and male coupling are constructed of UV-resistant materials, thereby prolonging the life and functionality of these components when exposed to sunlight.

In some embodiments, an integrated water filter can be positioned proximate to or within the male coupling, ensuring that the water passing through the hose is clean and free of contaminants.

Some embodiments further comprise an integrated hose reel, facilitating convenient storage of the hose tube.

In some embodiments, to ensure efficient water flow without wastage, the male coupling can be equipped with anti-leak couplings to prevent any unwanted water leakage.

Additionally, a separate embodiment focuses on the hose handle assembly which integrates the male coupling, bearing, and hand grip, but without a specific hose tube. A built-in water filter, quick-connect fittings for the male coupling, and a lubrication channel for the bearing's smooth rotation are other features that can be incorporated.

The bearing used in the invention is designed to be durable, with some embodiments suggesting the use of stainless steel. To prevent wear and tear and ensure the longevity of the bearing, it may be sealed to prevent debris from entering, and the outer race can be fitted with a lubrication channel to guarantee smooth rotation.

In summary, the disclosed hose assembly and hose handle assembly offer improved usability, flexibility, and functionality over traditional hose designs by using a unique coupling mechanism and integrating features such as ergonomic hand grips, expandable hose designs, and UV-resistant materials.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a top plan view of a hose assembly according to one embodiment of the present invention.

FIG. 2 is an exploded view thereof.

FIG. 3 is a front elevational cross-sectional view of a hand grip and coupling linking according to one embodiment of the present invention at vertical plane A-A in FIG. 1.

FIG. 4 is a top plan view of the hose assembly of FIG. 1 with the internal dimensions of the hand grip depicted in dashed lines.

### DETAILED DESCRIPTION OF THE INVENTION

In the following description, to better understand the aforementioned purposes, features, and advantages of the present invention, numerous specific details are set forth in order to provide a thorough understanding of the claimed subject matter. It should be noted that these details and examples are provided to merely aid in understanding the descriptions, and they do not, in any way, limit the scope of the present invention. The present invention can also be implemented in other modes different from those described herein and the present invention is not limited to the specific embodiments disclosed below.

As used herein, the singular forms “a”, “an” and “the” are intended to include the plural forms as well, unless expressly stated otherwise. It will be further understood that the terms “includes”, “comprises ”, “including” and/or “comprising” when used in this specification, specify the presence of stated features, integer steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

No element, act, or instruction used herein should be construed as critical or essential unless explicitly described as such.

The present invention relates to a novel hose assembly that provides enhanced functionality and flexibility over conventional hose designs. At its core, this hose assembly incorporates a unique combination of a male coupling, bearing, and hand grip system.

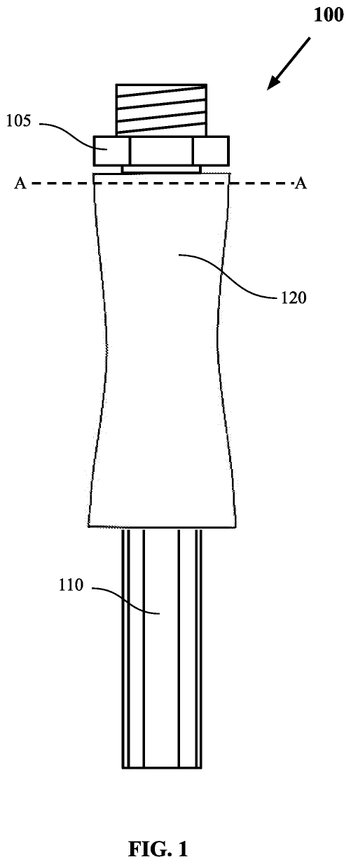

Referring now to the drawings in detail, wherein like numerals indicate like elements throughout the several figures, FIGS. 1 to 3 illustrate a hose assembly 100 according to one embodiment of the present invention.

FIG. 1 illustrates a top plan view of a hose assembly 100 according to one embodiment of the present invention. As visible from the exterior, the hose assembly 100 comprises a male coupling 105 affixed to the proximate end of the hose tube 110. A hand grip 120 surrounds the hose tube 110.

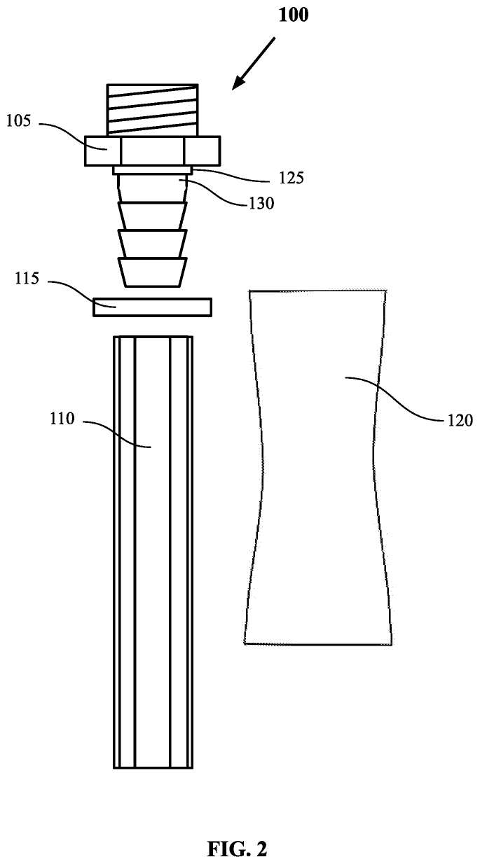

FIG. 2 illustrates an exploded view of the hose assembly 100 of FIG. 1 that serves to showcase its individual components. When assembled, a bearing system 115 is directly connected to the male coupling 105 at area 130 next to the proximal stopper 125 of the male coupling 105 and the proximate end of the hose tube 100 is securely fastened to the distal end of the male coupling 105. In the preferred embodiment, the bearing 115 is connected to the male coupling 105 by friction.

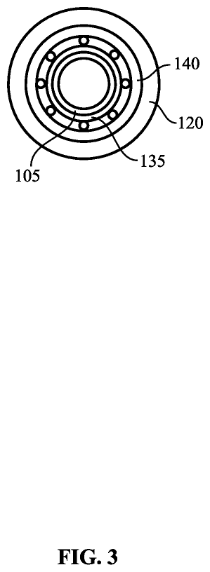

FIG. 3 illustrates a front elevational cross-sectional view of a hand grip and coupling linking according to one embodiment of the present invention at vertical plane A-A in FIG. The outer race 140 of the bearing is rotatably coupled to the inner race 135 of the bearing which itself is fixedly attached to area 130 (see FIG. 2) of the male coupling 105. The hand grip 120 is attached to the outer race 140 of the bearing. The internal dimensions of the handgrip 120, designed to attach to the bearing through friction, can be more clearly seen in

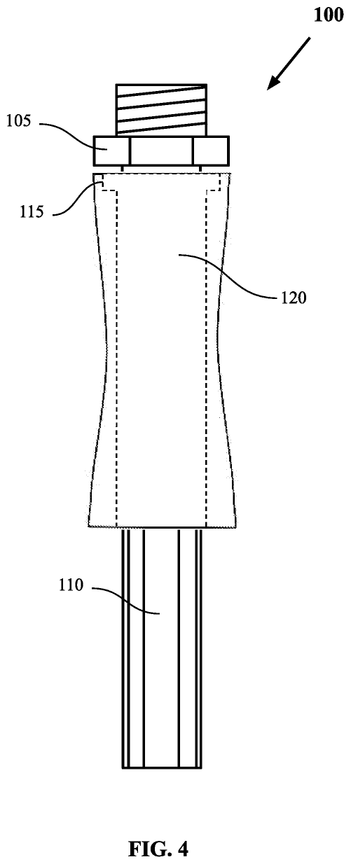

FIG. 4 depicted in dashed lines. This design is configured to mitigate the issue of kinking, as the hose tube and coupling can rotate independently of the hand grip during use.

In some embodiments, the inner race of the bearing is fixedly attached to the male coupling without being stabilized or held in place by the stoppers.

Some embodiments emphasize user comfort, with the hand grip sculpted to reduce strain and fatigue during use.

Some embodiments allow the hose tube to expand in order to optimize storage when the hose assembly is not in use.

Some embodiments have elements such as the hand grip, the coupling, and/or the hose tube constructed from materials resistant to UV damage, ensuring longevity even when frequently exposed to sunlight.

Some embodiments comprise an integrated water filter positioned close to or within the coupling.

Some embodiments incorporate a built-in hose reel.

Some embodiments utilize modern anti-leak coupling that minimize water wastage.

Although the present invention has been described in detail with reference to certain preferred configurations thereof, other embodiments are possible. Therefore, the spirit and scope of the invention should not be limited to the embodiments described above.

What is claimed is:

1. A hose assembly comprising:
a hose tube with a proximal end and a distal end;
a coupling affixed to the proximal end of the hose tube;
a bearing comprising:
an inner race attached to the coupling; and,
an outer race rotatably coupled to the inner race;
a hand grip comprising:
a proximal end fixedly attached to the outer race of the bearing; and,
a distal end extending away from the bearing.

2. The hose assembly of claim 1, wherein the hand grip includes ergonomic features for enhanced user comfort.

3. The hose assembly of claim 1, wherein the hose tube has an expandable design.

4. The hose assembly of claim 1, wherein the hand grip and coupling are constructed of UV-resistant materials.

5. The hose assembly of claim 1, further comprising a built-in water filter located proximate to or within the coupling.

6. The hose assembly of claim 1, further comprising an integrated hose reel for storing the hose tube.

7. The hose assembly of claim 1, wherein the coupling includes anti-leak couplings to prevent water leakage.

8. A hose handle assembly comprising:
a coupling;
a bearing, further comprising:
an inner race fixedly attached to the coupling; and
an outer race rotatably coupled to the inner race;
a hand grip having a proximal end attached to the outer race of the bearing.

9. The hose handle assembly of claim 8, wherein the hand grip includes ergonomic grips.

10. The hose handle assembly of claim 8, wherein the hand grip and coupling are constructed of UV-resistant materials.

11. The hose handle assembly of claim 8, further comprising a built-in water filter located proximate to or within the coupling.

12. The hose handle assembly of claim 8, wherein the hand grip includes a disengagement mechanism, the mechanism being configured such that, upon activation, the hand grip detaches from the outer race of the bearing.

13. The hose handle assembly of claim 8, wherein the coupling includes anti-leak couplings.

14. The hose handle assembly of claim 8, wherein the bearing is made of stainless steel.

15. The hose handle assembly of claim 8, wherein the coupling is designed for quick-connect fittings.

16. The hose handle assembly of claim 8, wherein the bearing is sealed to prevent debris from entering.

17. The hose handle assembly of claim 8, wherein the outer race includes a lubrication channel for smooth rotation.
